(19) United States
(12) Patent Application Publication
(10) Pub. No.: US 2026/0167047 A1
(43) Pub. Date: Jun. 18, 2026

(54) METHOD FOR PRIORITIZING CHARGING MULTIPLE VEHICLES AT PUBLIC AND RESIDENTIAL SPACE

(71) Applicant: GM Global Technology Operations LLC, Detroit, MI (US)

(72) Inventors: Aravind Subramanian, Ypsilanti, MI (US); Christine E. Cabrera, Ann Arbor, MI (US); Cameron Christopher Rose, Heiskell, TN (US); Balmukund Agarwal, Rochester Hills, MI (US); Shaun C. Bowman, Ann Arbor, MI (US)

(21) Appl. No.: 18/982,065

(22) Filed: Dec. 16, 2024

(51) Int. Cl. B60L 53/67; B60L 53/18; B60L 53/53

(52) U.S. Cl. CPC B60L 53/67; B60L 53/18; B60L 53/53; B60L 2250/00

(57) ABSTRACT

A charging station includes a first charging cord, a second charging cord, a third charging cord, and a processor. The processor is configured to receive a first departure time and first power requirement for a first vehicle, charge the first vehicle at a first charging rate to meet the first departure time, receive a second departure time and second power requirement for a second vehicle, charge the second vehicle at a second charging rate to meet the second departure time, receive a third departure time and third power requirement for a third vehicle, pause charging of at least one of the first vehicle and the second vehicle, and charge the third vehicle at the charging station while the at least one of the charging of the first vehicle and the charging of the second vehicle is paused.

The subject disclosure relates to charging of electric vehicles and, in particular, to a method for arbitrating the charging of multiple vehicles at a charging station without having to unplug a vehicle from the charging station to accommodate another vehicle.

Vehicles can connect to charging stations when out in public or at home. Most charging stations include only two plugs and can only charge two vehicles at the same time due to power limitations based on the power grid. However, a charging station generally has a power limit based on a power grid. The power can be distributed only to those vehicles that are plugged into the charging station. Any additional vehicles that arrive after the original two vehicle have plugged in have no access to this power until at least one of the two vehicles is unplugged from the charging station and moved out of the parking spot. Accordingly, it is desirable to provide a charging station and method to arbitrate power delivery at a charging station to accommodate multiple vehicles without having to unplug a vehicle from the charging station to accommodate another vehicle.

### SUMMARY

In one exemplary embodiment, a method of operating a charging station is disclosed. A first departure time and first power requirement for a first vehicle are received when the first vehicle is coupled to a charging station. The first vehicle is charged at a first charging rate to meet the first departure time for the first vehicle. A second departure time and second power requirement for a second vehicle are received when the second vehicle is coupled to the charging station after the first vehicle is coupled to the charging station. The second vehicle is charged at a second charging rate to meet the second departure time for the second vehicle. A third departure time and third power requirement for a third vehicle are received when the third vehicle is coupled to the charging station after the first vehicle and the second vehicle are coupled to the charging station. Charging is paused for at least one of the first vehicle and the second vehicle, whereas charging of the first vehicle is paused when at least one of a first estimated charging time for the first vehicle is earlier than the first departure time and charging of the second vehicle is paused when a second estimated charging time for the second vehicle is earlier than the second departure time. The third vehicle is charged at the charging station while at least one of the charging of the first vehicle and the charging of the second vehicle is paused.

In addition to one or more of the features described herein, the method further includes transferring power to the third vehicle from the one of the first vehicle and the second vehicle for which charging is paused.

In addition to one or more of the features described herein, the method further includes requesting a permission from an owner of the one of the first vehicle and the second vehicle for which charging is paused to discharge power from the one of the first vehicle and the second vehicle to the third vehicle.

In addition to one or more of the features described herein, the method further includes establishing a first priority for the first vehicle and a second priority the second vehicle and providing a first charge power for the first vehicle and a second charge power for the second vehicle based on the first priority and the second priority.

In addition to one or more of the features described herein, the method further includes establishing the first priority and the second priority based on a first utility curve for the first vehicle and a second utility curve for the second vehicle.

In addition to one or more of the features described herein, the method further includes resuming charging of the one of the first vehicle and the second vehicle when one of a calculated remaining charging time for the first vehicle is equal to or greater than a difference between the first departure time for the first vehicle and a current time and the calculated remaining charging time for the second vehicle is equal to or greater than a difference between the second departure time for the second vehicle and the current time.

In addition to one or more of the features described herein, the charging station is one of a public charging station and a residential charging station.

In another exemplary embodiment, a charging station is disclosed. The charging station includes a first charging cord for connecting to a first vehicle, a second charging cord for connecting to a second vehicle, a third charging cord for connecting to a third vehicle, and a processor. The processor is configured to receive a first departure time and first power requirement for the first vehicle when the first vehicle is coupled to the charging station, charge the first vehicle at a first charging rate to meet the first departure time for the first vehicle, receive a second departure time and second power requirement for the second vehicle when the second vehicle is coupled to the charging station after the first vehicle is coupled to the charging station, charge the second vehicle at a second charging rate to meet the second departure time for the second vehicle, receive a third departure time and third power requirement for a third vehicle when the third vehicle is coupled to the charging station after the first vehicle and the second vehicle are coupled to the charging station, pause charging of at least one of the first vehicle and the second vehicle, whereas charging of the first vehicle is paused when at least one of a first estimated charging time for the first vehicle is earlier than the first departure time and charging of the second vehicle is paused when a second estimated charging time for the second vehicle is earlier than the second departure time, and charge the third vehicle at the charging station while the at least one of the charging of the first vehicle and the charging of the second vehicle is paused.

In addition to one or more of the features described herein, the processor is further configured to transfer power to the third vehicle from the one of the first vehicle and the second vehicle for which charging is paused.

In addition to one or more of the features described herein, the processor is further configured to request a permission from an owner of one of the first vehicle and the second vehicle for which charging is paused to discharge power from the one of the first vehicle and the second vehicle to the third vehicle.

In addition to one or more of the features described herein, the processor is further configured to establish a first priority for the first vehicle and a second priority the second vehicle and provide a first charge power for the first vehicle and a second charge power for the second vehicle based on the first priority and the second priority.

In addition to one or more of the features described herein, the processor is further configured to establish the first priority and the second priority based on a first utility curve for the first vehicle and a second utility curve for the second vehicle.

In addition to one or more of the features described herein, the processor is further configured to resume charging of the one of the first vehicle and the second vehicle when one of a calculated remaining charging time for the first vehicle is equal to or greater than a difference between the first departure time for the first vehicle and a current time and the calculated remaining charging time for the second vehicle is equal to or greater than a difference between the second departure time for the second vehicle and the current time.

In addition to one or more of the features described herein, the charging station is one of a public charging station and a residential charging station.

In yet another exemplary embodiment, a charging system is disclosed. The charging system include a charging station for charging a first vehicle, a second vehicle and a third vehicle, and a back office including a processor. The processor is configured to receive a first departure time and first power requirement for the first vehicle when the first vehicle is coupled to the charging station, charge the first vehicle at a first charging rate to meet the first departure time for the first vehicle, receive a second departure time and second power requirement for the second vehicle when the second vehicle is coupled to the charging station after the first vehicle is coupled to the charging station, charge the second vehicle at a second charging rate to meet the second departure time for the second vehicle, receive a third departure time and third power requirement for a third vehicle when the third vehicle is coupled to the charging station after the first vehicle and the second vehicle are coupled to the charging station, pause charging of at least one of the first vehicle and the second vehicle, whereas charging of the first vehicle is paused when at least one of a first estimated charging time for the first vehicle is earlier than the first departure time and charging of the second vehicle is paused when a second estimated charging time for the second vehicle is earlier than the second departure time, and charge the third vehicle at the charging station while the at least one of the charging of the first vehicle and the charging of the second vehicle is paused.

In addition to one or more of the features described herein, the charging station is configured to request a permission from an owner of one of the first vehicle and the second vehicle which is paused to discharge power from the one of the first vehicle and the second vehicle to the third vehicle.

In addition to one or more of the features described herein, the processor is further configured to request a permission from an owner of one of the first vehicle and the second vehicle for which charging is paused to allow transfer of power to the third vehicle.

In addition to one or more of the features described herein, the processor is further configured to establish a first priority for the first vehicle and a second priority the second vehicle and provide a first charge power for the first vehicle and a second charge power for the second vehicle based on the first priority and the second priority.

In addition to one or more of the features described herein, the processor is further configured to establish the first priority and the second priority based on a first utility curve for the first vehicle and a second utility curve for the second vehicle.

In addition to one or more of the features described herein, the processor is further configured to resume charging of one of the first vehicle and the second vehicle when one of a calculated remaining charging time for the first vehicle is equal to or greater than a difference between the first departure time for the first vehicle and a current time and the calculated remaining charging time for the second vehicle is equal to or greater than a difference between the second departure time for the second vehicle and the current time.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 shows a vehicle in accordance with an exemplary embodiment;

FIG. 2 shows a top view of the charging station as part of a charging network;

FIG. 3 shows a top view of the charging station with two electric vehicles;

FIG. 4 shows a top view of the charging station with three electric vehicles;

FIG. 5 shows a top view of the charging station with four electric vehicles;

FIG. 6 shows a top view of the charging station with four electric vehicles at a later time;

FIG. 7 shows a top view of the charging station at a later time in the day;

FIG. 8 is charging control arbitration chart for vehicles at a charging station;

FIG. 9 is a flowchart of decision logic used at the charging station to distribute energy across multiple cables;

FIG. 10 shows a charging network for charging vehicles;

FIG. 11 is a diagram of a smart power sharing algorithm that is performed at a back office;

FIG. 12 shows a user interface including inputs that can be provided to the back office;

FIG. 13 is a diagram of calculations performed for calculating energy needs for the charging station;

FIG. 14 shows graph of utility vs. charging range in an illustrative embodiment;

FIG. 15 is diagram of back office calculations for determining total available energy at a charger;

FIG. 16 is a diagram showing additional back office calculations for determining power limits; and

FIG. 17 shows a diagram of subsequent calculations at the vehicle.

### DETAILED DESCRIPTION

The following description is merely exemplary in nature and is not intended to limit the present disclosure, its application or uses. It should be understood that throughout the drawings, corresponding reference numerals indicate like or corresponding parts and features.

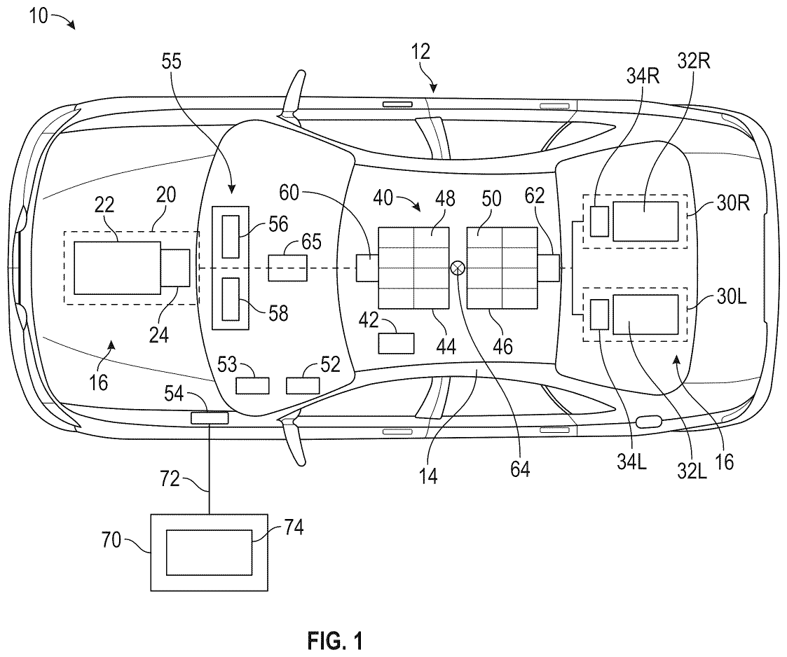

In accordance with an exemplary embodiment, FIG. 1 shows an embodiment of a vehicle 10, which includes a vehicle body 12 defining, at least in part, an occupant compartment 14. The vehicle body 12 also supports various vehicle subsystems including a propulsion system 16, and other subsystems to support functions of the propulsion system 16 and other vehicle components, such as a braking subsystem, a suspension system, a steering subsystem, and others.

The vehicle 10 may be an electrically powered vehicle (EV), a hybrid vehicle (HEV) or a plug-in hybrid electric vehicle (PHEV), in various embodiments. In an embodiment, the vehicle 10 is an electric vehicle that includes multiple motors and/or drive systems. Any number of drive units may be included, such as one or more drive units for applying torque to front wheels (not shown) and/or to rear wheels (not shown). The drive units are controllable to operate the vehicle 10 in various operating modes, such as a normal mode, a high-performance mode (in which additional torque is applied), all-wheel drive (“AWD”), front-wheel drive (“FWD”), rear-wheel drive (“RWD”) and others.

For example, the propulsion system 16 is a multi-drive system that includes a front drive unit 20 for driving front wheels, and rear drive units for driving rear wheels. The front drive unit 20 includes a front electric motor 22 and a front inverter 24 (e.g., front power inverter module or FPIM), as well as other components such as a cooling system. A left rear drive unit 30L includes a left rear electric motor 32L and a left rear inverter 34L. A right rear drive unit 30R includes a right rear electric motor 32R and a right rear inverter 34R. The front inverter 24, left rear inverter 34L and right rear inverter 34R (e.g., power inverter units or PIMs) each convert direct current (DC) power from a high voltage (HV) battery system 40 to poly-phase (e.g., two-phase, three-phase, six-phase, etc.) alternating current (AC) power to drive the front electric motor 22 the left rear electric motor 32L and the right rear electric motor 32R.

As shown in FIG. 1, the drive systems feature separate electric motors. However, embodiments are not so limited. For example, instead of separate motors, multiple drives can be provided by a single machine that has multiple sets of windings that are physically independent.

As also shown in FIG. 1, the drive systems are configured such that the front electric motor 22 drives the front wheels (not shown), and the left rear electric motor 32L and right rear electric motor 32R drive the rear wheels (not shown). However, embodiments are not so limited, as there may be any number of drive systems and/or motors at various locations (e.g., a motor driving each wheel, twin motors per axle, etc.). In addition, embodiments are not limited to a dual drive system, as embodiments can be used with a vehicle having any number of motors and/or power inverters.

In the propulsion system 16, the front drive unit 20, left rear drive unit 30L and right rear drive unit 30R are electrically connected to the battery system 40. The battery system 40 may also be electrically connected to other electrical components (also referred to as “electrical loads”), such as vehicle electronics (e.g., via an auxiliary power module or APM 42), heaters, cooling systems and others. The battery system 40 may be configured as a rechargeable energy storage system (RESS).

In an embodiment, the battery system 40 includes a plurality of separate battery assemblies, in which each battery assembly can be independently charged and can be used to independently supply power to a drive system or systems. For example, the battery system 40 includes a first battery assembly such as a first battery pack 44 connected to the front inverter 24, and a second battery pack 46. The first battery pack 44 includes a first plurality of battery modules 48, and the second battery pack 46 includes a second plurality of battery modules 50. Each of the first plurality of battery modules 48 and the second plurality of battery modules 50 includes a number of individual cells (not shown).

Each of the front electric motor 22 and the left rear electric motor 32L and right rear electric motor 32R is a three-phase motor having three phase motor windings. However, embodiments described herein are not so limited. For example, the motors may be any poly-phase machines supplied by poly-phase inverters, and the drive units can be realized using a single machine having independent sets of windings.

The battery system 40 and/or the propulsion system 16 includes a switching system having various switching devices for controlling operation of the first battery pack 44 and second battery pack 46, and selectively connecting the first battery pack 44 and second battery pack 46 to the front drive unit 20, left rear drive unit 30L and right rear drive unit 30R. The switching devices may also be operated to selectively connect the first battery pack 44 and the second battery pack 46 to a charging system. The charging system can be used to charge the first battery pack 44 and the second battery pack 46, and/or to supply power from the first battery pack 44 and/or the second battery pack 46 to charge another energy storage system (e.g., vehicle-to-vehicle (V2V) and/or vehicle-to-everything (V2X) charging). The charging system includes one or more charging modules. For example, a first onboard charging module (OBCM) 52 is electrically connected to a charge port 54 for charging to and from an AC system or device, such as a utility AC power supply, such as a charging station 70. A second OBCM 53 may be included for DC charging (e.g., DC fast charging or DCFC).

In an embodiment, the switching system includes a first switching device 60 that selectively connects to the first battery pack 44 to the front inverter 24, left rear inverter 34L and right rear inverter 34R, and a second switching device 62 that selectively connects the second battery pack 46 to the front inverter 24, left rear inverter 34L and right rear inverter 34R. The switching system also includes a third switching device 64 (also referred to as a “battery switching device”) for selectively connecting the first battery pack 44 to the second battery pack 46 in series.

Any of various controllers can be used to control functions of the battery system 40, the switching system and the drive units. A controller includes any suitable processing device or unit and may use an existing controller such as a drive system controller, an RESS controller, and/or controllers in the drive system. For example, a controller 65 may be included for controlling switching and drive control operations as discussed herein.

The vehicle 10 also includes a computer system 55 that includes one or more processing devices 56 and a user interface 58. The computer system 55 may communicate with the charging system controller, for example, to provide commands thereto in response to a user input. The various processing devices, modules and units may communicate with one another via a communication device or system, such as a controller area network (CAN) or transmission control protocol (TCP) bus.

The charging station 70 can include a charging cord 72 that can be used to electrically couple the charging station to the vehicle 10. Although, a single charging cord is shown, the charging station 70 can include a plurality of charging cords, in various embodiments. The charging station 70 can include a controller 74 that controls various aspects and methods for charging a plurality of vehicles.

“The controller 74 may include processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality. The controller 74 may also include a non-transitory computer-readable medium that stores instructions which are processed by one or more processors of the controller to implement processes detailed herein. The methods allow the charging station 70 to schedule the charging of multiple vehicles to meet customer demand and without drawing additional power from a power grid, as disclosed herein.

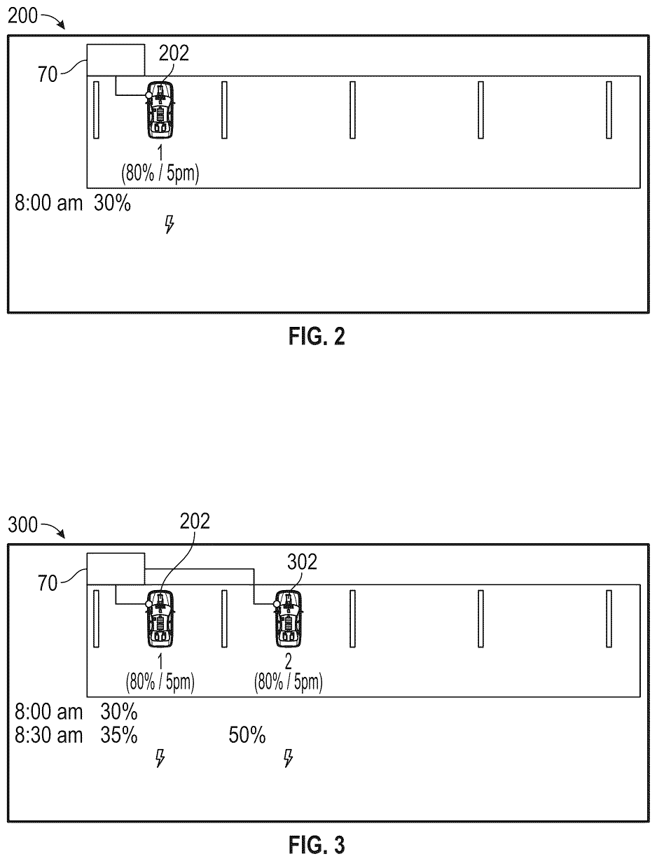

FIGS. 2-10 describe priority changing at a public charging station. FIG. 2 shows a top view 200 of the charging station 70 as part of a charging network. The charging station 70 is shown to have four charging cords for charging four separate vehicles, for illustrative purposes. However, in various embodiments, the charging station can have any number of charging cords for charging any number of vehicles. When a vehicle connects to the charging station, a power requirement and a departure time of the vehicle is received at the charging station, either by being manually entered or by sending a signal over a communication line between the vehicle and the charging station. Alternatively, the power requirement and departure time can be sent using a mobile device running an application. The charging station 70 then charges the vehicle at a suitable charging rate to provide the requested power to the vehicle by the time that the vehicle is set to depart. The charging station can calculate an estimated charging time based on the data.

A first vehicle 202 is shown docked at the charging station 70. The first vehicle 202 arrives at the charging station with 30% of full power. The charging station 70 receives a first departure time and a first power requirement and charges the first vehicle 202 at a first charging rate to meet the first power requirement by the first departure time. For illustrative purposes, the first vehicle 202 arrives at 8:00 a.m., has a power requirement to be at 80% full power by 5 p.m.

FIG. 3 shows a top view 300 of the charging station 70 with two electric vehicles. The first vehicle 202 and the second vehicle 302 are connected to the charging station 70. The second vehicle 302 arrives at 8:30 a.m. at 50% of full power. At the time of arrival of the second vehicle 302, the first vehicle 202 is charged to 35% of full power. The second vehicle 302 provides the charging station 70 with a second power requirement of 80% of full power by a second departure time of 5:00 p.m.

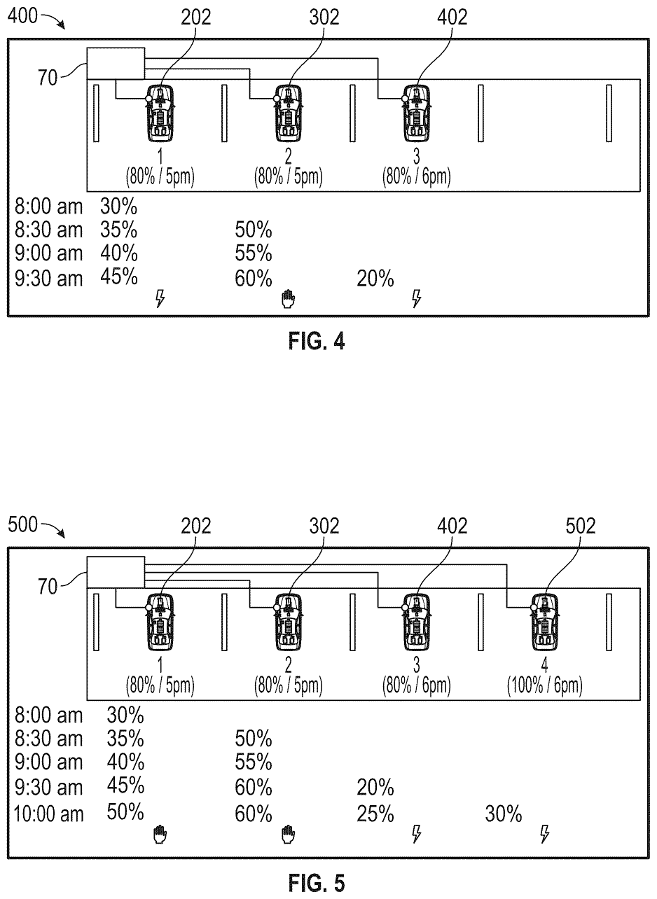

FIG. 4 shows a top view 400 of the charging station 70 with three electric vehicles. The first vehicle 202, the second vehicle 302 and a third vehicle 402 are connected to the charging station 70. The third vehicle 402 arrives at 9:30 a.m. at 20% of full power and has a third power requirement of 80% by a third departure time of 6:00 μm. At the time of arrival of the third vehicle 402, the first vehicle 202 has charged to 45% full power and the second vehicle 302 has charged to 60% of full power. With three vehicles plugged in, the charging station 70 understands the limitations of the grid power and does not charge the third vehicle 402 immediately. However, based on the current parameters of the second vehicle 302 (such as a current SOC and target charge level for the second vehicle), the charging station 70 determines that the second vehicle 302 can complete its charging prior to its departure time. The charging station 70 therefore pauses the charging of the second vehicle 302 in order to meet the requirements of the third vehicle 402.

The second vehicle can be selected for pausing over the first vehicle based on various parameters. For example, the second vehicle is closer to reaching its power goals than the first vehicle. Therefore, pausing the second vehicle has the least associated risk with regard to having all of the vehicles be charged before their respective departure times.

FIG. 5 shows a top view 500 of the charging station 70 with four electric vehicles. The first vehicle 202, the second vehicle 302, the third vehicle 402 and a fourth vehicle 502 are connected to the charging station 70. The fourth vehicle 502 arrives at 10:00 a.m. at 30% of full power, has fourth power requirement of 100% full power by a fourth departure time of 6:00 μm. At this time, the first vehicle 202 has charged to 50% full power, the second vehicle 302 is paused at 60% of full power, and the third vehicle 402 is at 25% full power. The charging station 70 determines that, based on power and time requirements, it can pause the charging of the first vehicle 202 in order to meet the requirements of the fourth vehicle 502.

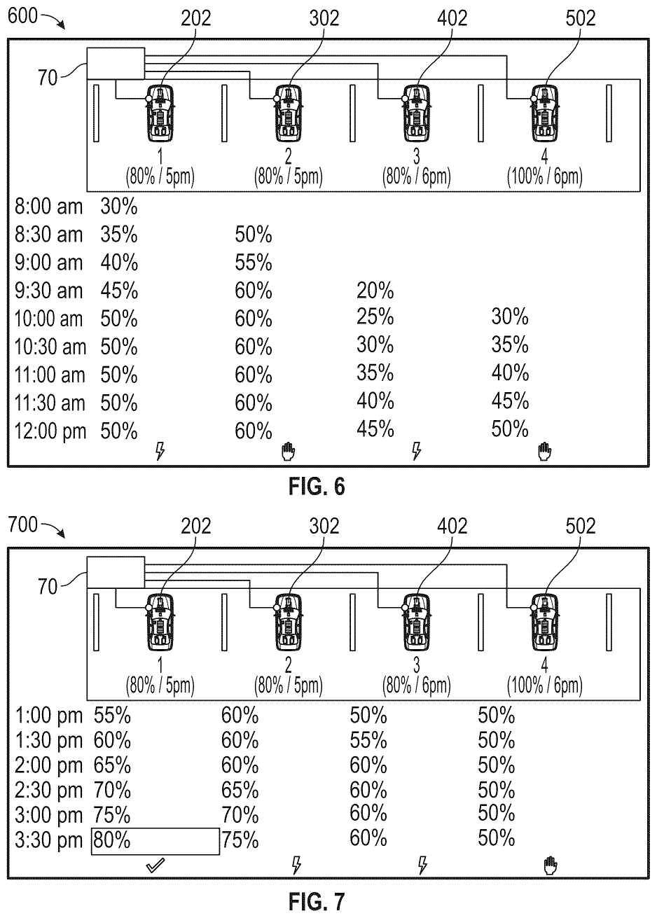

FIG. 6 shows a top view 600 of the charging station 70 with four electric vehicles at a later time. At 12:00 p.m. (noon), charging of the fourth vehicle 502 has been paused to allow the first vehicle 202 to continue charging, thereby allowing the first vehicle to meet its power requirement by its departure time. The first vehicle 202 has priority over the fourth vehicle 502. The priority can be set either by the customer (for a residential charging station) or on a first-come-first-served basis (for a public charging station). The fourth vehicle 502 is paused at 50% full power. At this time, the second vehicle 302 remains paused at 60% power and the third vehicle 402 continues charging but is currently at 45% full power.

FIG. 7 shows a top view 700 of the charging station 70 at a later time in the day. At 3:30 p.m., the first vehicle 202 has reached is power requirements (80% full power). The charging station 70 has turned off charging to the first vehicle 202. The charging of the second vehicle 302 has been restarted earlier upon completion of the charging of the first vehicle 202. (The second vehicle has priority over the third vehicle and the fourth vehicle). At 3:30 p.m., the second vehicle 302 is at 75% full power, the third vehicle 402 is at 60% full power and the fourth vehicle 502 is paused at 50% full power.

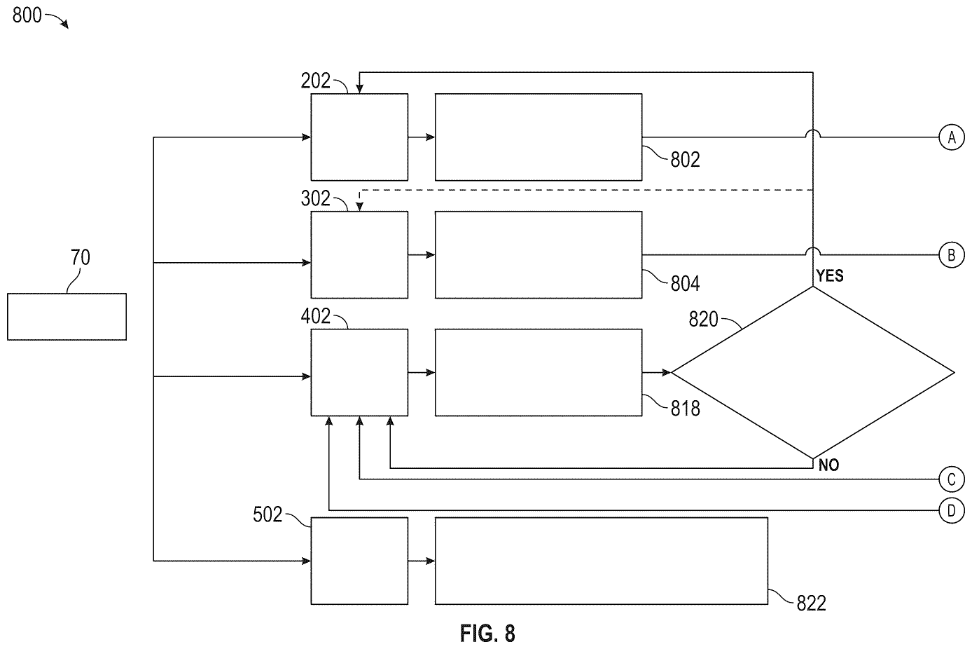

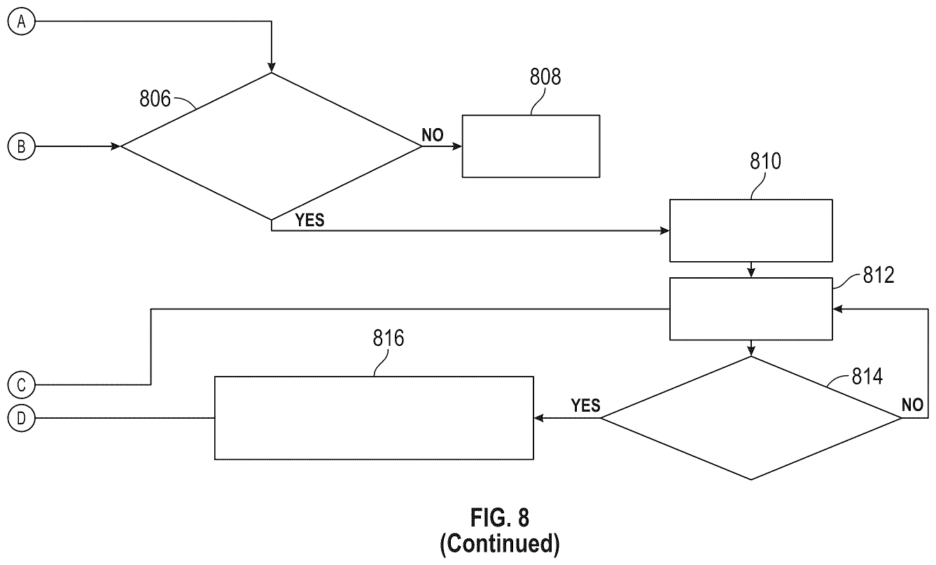

FIG. 8 is charging control arbitration chart 800 for vehicles at a charging station. The charging control arbitration chart 800 shows the charging station 70, first vehicle 202, second vehicle 302, third vehicle 402 and fourth vehicle 502. Four vehicles are shown for illustrative purposes only. In various embodiments, any number of vehicles can be at the charging station. The numbering of the vehicles indicates which vehicle arrived at the charging station first and therefore indicates a priority of the vehicle with respect to the other vehicles. For example, the first vehicle arrives before the second vehicle and has priority over the second vehicle, etc.

As the first vehicle 202 connects to the charging station 70, the charging station immediately begins charging the first vehicle. In box 802, the first vehicle shares its energy requirements and departure time with the charging station. As the second vehicle 302 connects to the charging station 70, the charging station immediately begins charging the second vehicle along with the first vehicle. In box 804, the second vehicle 302 shares its energy requirements and departure time with the charging station. As the third vehicle 402 connects to the charging station 70, the charging station places the third vehicle on a waitlist.

In decision box 806, the calculated charge time for each vehicle (e.g., each of the first vehicle 202 and the second vehicle 320) is compared to their departure times. If the calculated charge times are later than the respective departure times, the method proceeds to box 808. In box 808, the charging station 70 charges the first vehicle 202 and the second vehicle 302. Returning to decision box 806, if calculations show that a vehicle will be charged prior to its departure time), the method proceeds to box 810.

In box 810, the charging station 70 selects either the first vehicle or the second vehicle for pausing. In box 812, the charging station 70 begins charging the third vehicle 402 using energy from the grid. In box 814, the owner of the paused vehicle (either the first vehicle 202 or the second vehicle 302) can be asked for permission to be used to charge the third vehicle 402 by having its energy discharged or transferred to the third vehicle. This request is most likely to occur during peak grid hours. If the owner denies the request, the method returns to box 812 to continue charging the third vehicle 402 from the grid. Otherwise, the method proceeds from box 814 to box 816. In box 816, the third vehicle 402 is charged using both grid energy from the charging station and energy from the paused vehicle.

In box 818, the charging station monitors the energy provided from the paused vehicle to the third vehicle. The charging station periodically recalculates the remaining charging time for the paused vehicle.

In box 820, the charging station 70 decides whether to continue charging the third vehicle or to return to charging the paused vehicle. If the remaining charging time for the paused vehicle (based on calculations in box 818) is equal to or greater than a difference between the stated departure time for the vehicle and the current time, or if the owner of the paused vehicle chooses to resume charging, the method returns to charging the paused vehicle (either the first vehicle or the second vehicle). If none of these scenarios occurs, the method continues charging the third vehicle 402.

The fourth vehicle 502 can be coupled to the charging station 70. In box 822, the fourth vehicle 502 starts to receive energy if either of the first vehicle 202 and the second vehicle 302 is finished charging or the energy being consumed by the currently charging vehicles (i.e., any combination of the first vehicle, second vehicle and third vehicle) is less than the available energy of the charging station.

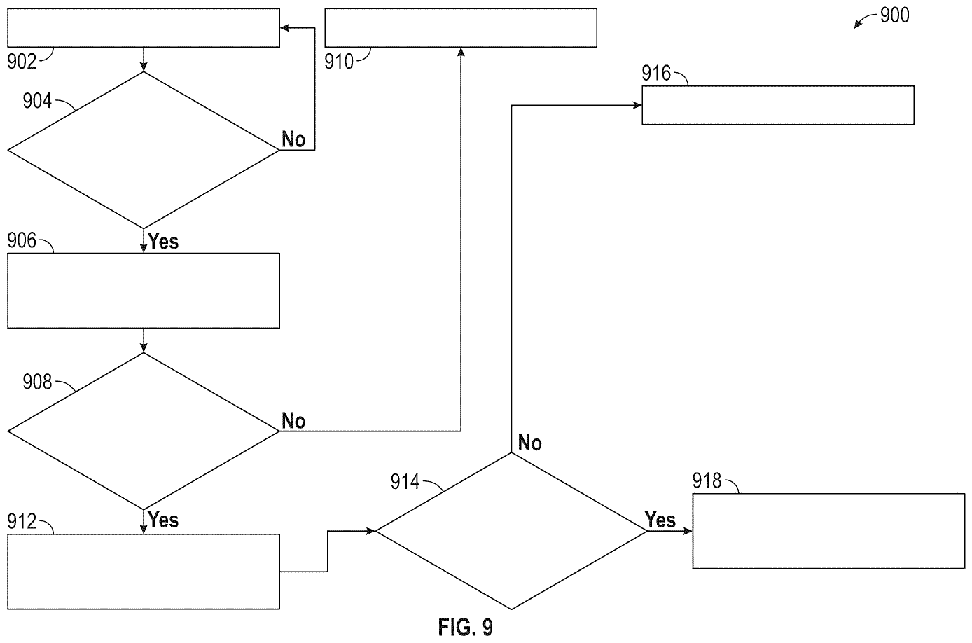

FIG. 9 is a flowchart 900 of decision logic used at the charging station to distribute energy across multiple cables. The method begins in box 902 with the first vehicle 202 currently charging. In box 904, the charging requirements of the first vehicle 202 are monitored. If the charging energy of the first vehicle is equal to the maximum available power of the charging station, the method returns to box 902. Otherwise, in box 904, if the vehicle is charging at a power below the maximum available power form the station for that plug, the method proceeds to box 906.

In box 906, the remaining power of the charging station (the total power of the station minus the power being provided to the first vehicle) is used to charge the second vehicle 302. In box 908, if the charging power required for the second vehicle 302 is equal to the maximum available charging power from the charging station, the method proceeds to box 910. In box 910, the second vehicle is charged. Returning to box 908, if the charging power required for the second vehicle 302 is less than the maximum available charging power from the charging station at that time, the method proceeds to box 912.

In box 912, the remaining power of the charging station is used to charge the third vehicle. This process is continued in boxes 914, 916 and 918 for any number vehicles. In box 914, if the charging power required for the n^{th} vehicle is greater than the maximum available charging power from the charging station at that time, the method proceeds to box 916, where the n^{th} vehicle is charged. Otherwise, the method proceeds to box 918. In box 918, the remaining power of the charging station is used to charge the (n+1)^{th} vehicle.

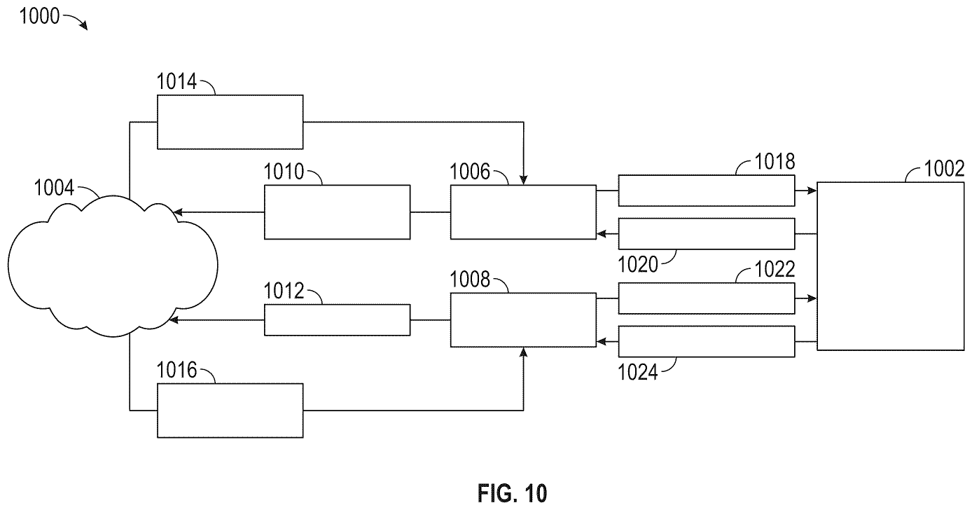

FIG. 10 shows a charging network 1000 for charging vehicles. FIG. 10 illustrates data flow within the charging network 1000. The charging network 1000 includes a charger 1002, a back office 1004 and various vehicles, as shown illustratively by a first vehicle 1006 and a second vehicle 1008. The charger 1002 can be a public charger or residential charger, such as a charger located in a garage of a residence. The vehicles are in communication with the charger 1002 and the back office 1004. The first vehicle 1006 provide a first vehicle data 1010 to the back office 1004 and the second vehicle 1008 provides a second vehicle data 1012 to the back office. The back office 1004 calculates charging limits using the first vehicle data 1010 and/or second vehicle data 1012 and provides the charging limits to the charger 1002. A first charging limit 1014 is provided to the first vehicle 1006 and a second charging limit 1016 is provided to the second vehicle 1008. The first vehicle 1006 can send a first power request 1018 to the charger 1002 and the charger can send a first charger limit 1020 to the first vehicle. Similarly, the second vehicle 1008 can send a second power request 1022 to the charger 1002 while the charger can send a second charger limit 1024 to the second vehicle.

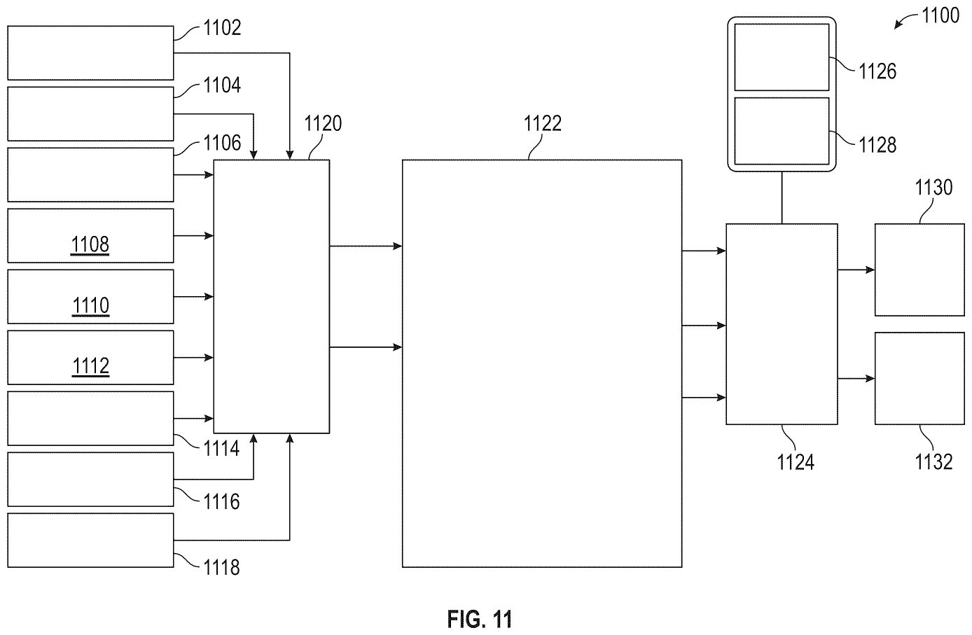

FIGS. 11-16 describe priority charging at a residential charging station. FIG. 11 is a diagram 1100 of a smart power sharing algorithm that is performed at a back office. The back office receives various input from the vehicles, including charging limits, target settings and temporal parameters. Charging limits can include electric vehicle limits 1102, charging station limits 1104, and/or home limits 1106. Target settings can include a target charge level 1108 (TCL) and a current state of charge (current SOC[i] 1110) of the various vehicles coupled to the charging station. Temporal parameters can include a current time 1112, a departure time 1114, a current battery capacity 1116 and a schedule 1118. The schedule 1118 indicates preferred charging time slots for the vehicle.

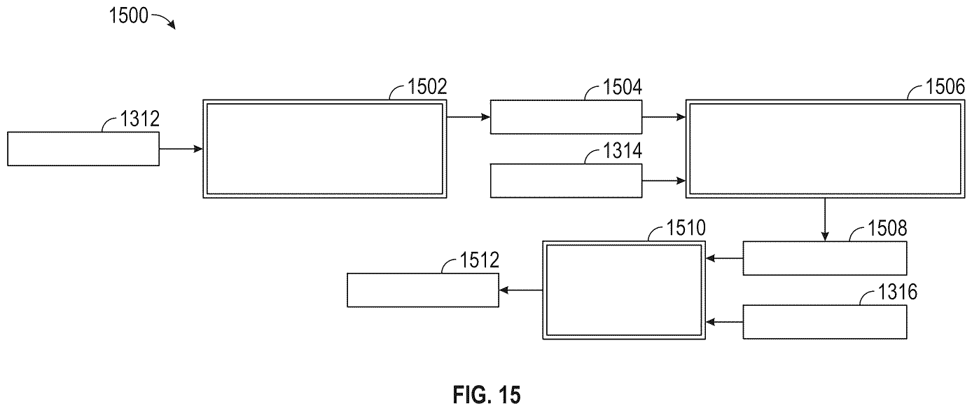

In box 1120, the back office 1004 calculates total energy needs for up to n vehicles and calculates a total energy available for charging based on these parameters. Details of box 1122 are discussed herein with respect to FIG. 15.

In box 1124, charge power limits are calculated based on the selected weighting (from either box 1126 or box 1128) and total capacity inputs from the vehicles. From box 1124, the method proceeds to either or both of boxes 1130 and 1132. In box 1130, the charging power limit for the first vehicle are provided to the first vehicle. In box 1132, the charging power limit for the second vehicle are provided to the second vehicle.

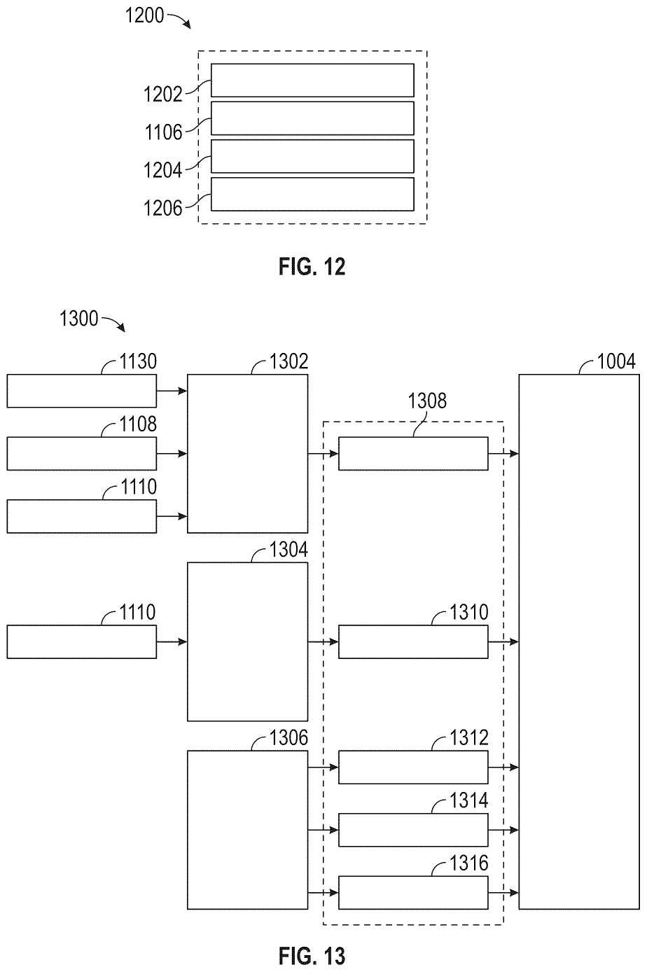

FIG. 12 shows a user interface 1200 including inputs that can be provided to the back office 1004. The user interface 1200 can be an application operating on a mobile device, such as a smartphone, a human machine interface at the vehicle, etc. The inputs include a priority of the vehicle 1202, a charging capacity of the home or residence (home limits 1106), priority charging active bit 1204, and a number n of vehicles 1206. Each vehicle at the charging station is assigned a priority. A sum of the priorities of the vehicles is defined as equal to 100.

FIG. 13 is a diagram 1300 of calculations performed for calculating energy needs for the charging station. The calculations can be performed at the vehicle, at the back office or at a combination of the vehicle and the back office. The calculations are performed using various parameters such as high voltage battery capacities for the vehicles (HVBattCap[i] 1130), target SOCs for the vehicles (TargetSOC[i] 1108), and current SOC for the vehicles (CurrentSOC[i] 1110). In box 1302, the total energy need (TotEnergyNeed 1308) is calculated, as shown in Eq. (1):

$$TotEnergyNeed = {\sum }_{i = 0}^{n} ( HVBattCap [ i ] * TargetSOC [ i ] - CurrentSOC [ i ] ) \qquad Eq . ( 1 )$$

In box 1304, a marginal utility 1310 is calculated using the current SOC (Current SOC[i] 1110). In box 1306, vehicle software of each vehicle provides a charger capacity (ChargerCap[i] 1312) a home charger capacity (HomeCap 1314) and a total active charging time (TotActvChrgTm[i] 1316). The total energy need, marginal utility, charger capacity, home charger capacity and total active charger time are provided to the back office 1004.

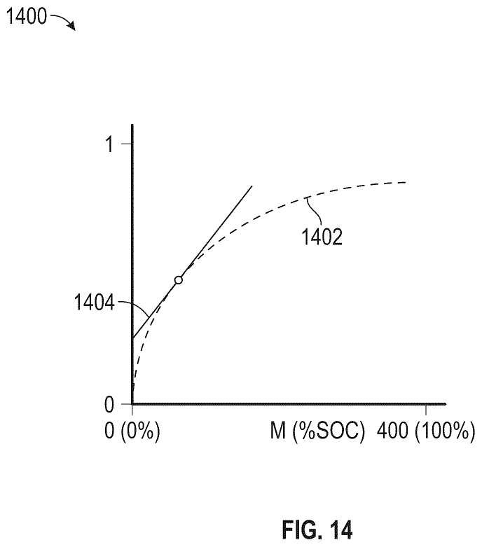

FIG. 14 shows graph 1400 of utility vs. charging range in an illustrative embodiment. Range is shown along the abscissa in miles (and can alternatively be shown in percentage of full charge (% SOC) and utility is shown as a value between 0 and 1 along the ordinate axis, although the value along the ordinate axis can be from 0% to 100% or another useful metric. Curve 1402 represents utility vs. range. A marginal utility for a selected SOC can be determined by taking a slope 1404 of the curve 1402 at the selected SOC. The marginal utility can be sent to the back office for use in making decisions with respect to charging the vehicle.

FIG. 15 is diagram 1500 of back office calculations for determining total available energy at a charger. The diagram 1500 describes calculations performed in box 1122 of FIG. 11. The charger communicates its limits/capacity to the vehicle which passes it to the back office. In box 1502, a summing device sums the charger capacities 1312 for each of n vehicles at a residential charger to obtain a Total Charger Capacity 1504. In box 1506, a maximum total power 1508 is determined as a minimum value selected from the Total Charger Capacity 1504 and the Home Capacity (HomeCap 1314). In box 1510, the maximum total power 1508 is multiplied by the total active charging time 1316 to output a total available energy 1512.

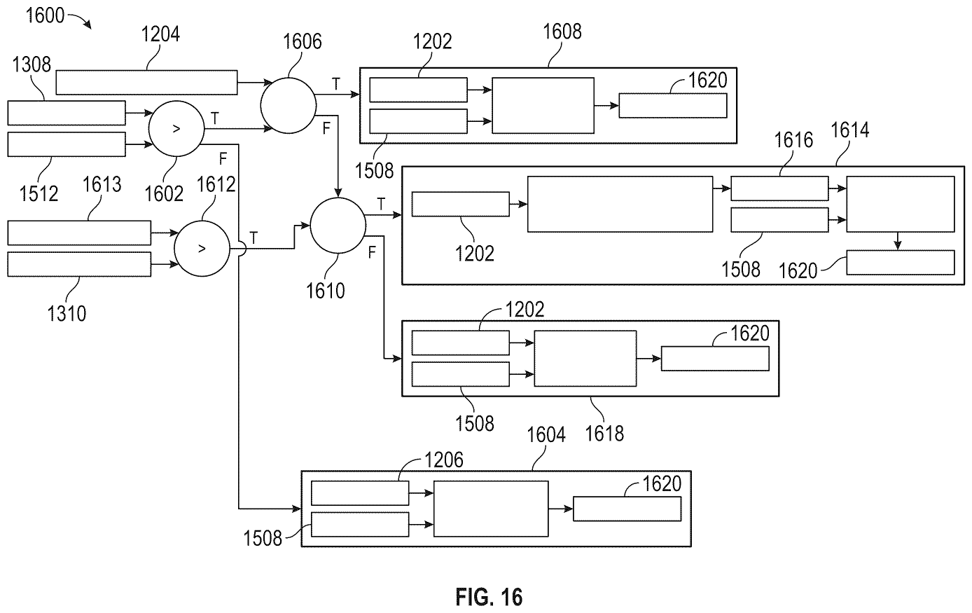

FIG. 16 is a diagram 1600 showing additional back office calculations for determining power limits. The diagram 1600 describes calculations performed in box 1124 of FIG. 11. The total energy needs (TotEnergyNeed 1308) at the charger and the total energy available 1512 are compared to each other at a first comparator 1602. If the total energy needs (TotEnergyNeed 1308) are greater than the total energy available 1512, the first comparator 1602 outputs a TRUE value. Otherwise, a FALSE value is output. If the output of the first comparator 1602 is FALSE, the method proceeds to box 1604. In box 1604, the power limit 1620 for the vehicle is calculated as shown in Eq. (2):

$$Power Limit [ i ] = Max TotPower / n \qquad Eq . ( 2 )$$

If the output of the first comparator 1602 is TRUE, the method proceeds to a first AND gate 1606. The comparator output (TRUE) and the value of the priority charging active bit 1204 are entered into the first AND gate 1606. If the output of the first AND gate 1606 is TRUE, the method proceeds to box 1608. In box 1608, the power limit 1620 for the vehicle is calculated as shown in Eq. (3):

$$Power Limit [ i ] = Max TotPower * Priority [ i ] \qquad Eq . ( 3 )$$

If the output of the first AND gate 1606 is FALSE, the method proceeds to a second AND gate 1610. The second AND gate 1610 receives the output of the first AND gate 1606 and the results of a marginal utility calculated from a second comparator 1612.

The second comparator 1612 compares the marginal utility 1310 to a marginal utility threshold 1613. The second comparator 1612 outputs a TRUE value when the marginal utility 1310 is less than the marginal utility threshold 1613. This value is sent to the second AND gate 1610 where it is input to an AND operation along with the output of the first AND gate 1606. If the second AND gate 1610 outputs a TRUE value, the method proceeds to box 1614.

In box 1614, the percentage power 1616 of the vehicle is calculated from the marginal utility, as shown in Eq. (4):

$$PctPwr [ i ] = ( MarginalUtility [ 1 ] ) / {\sum }_{i} MarginalUtility [ i ] \qquad Eq . ( 4 )$$

The power limit 1620 is then calculated as shown in Eq. (5):

$$Power Limit [ i ] = Max TotPower * PctPwr [ i ] \qquad Eq . ( 5 )$$

Returning to the second AND gate 1610, if the output is FALSE, the method proceeds to box 1618. In box 1618, the power limit 1620 is calculated using Eq. (3).

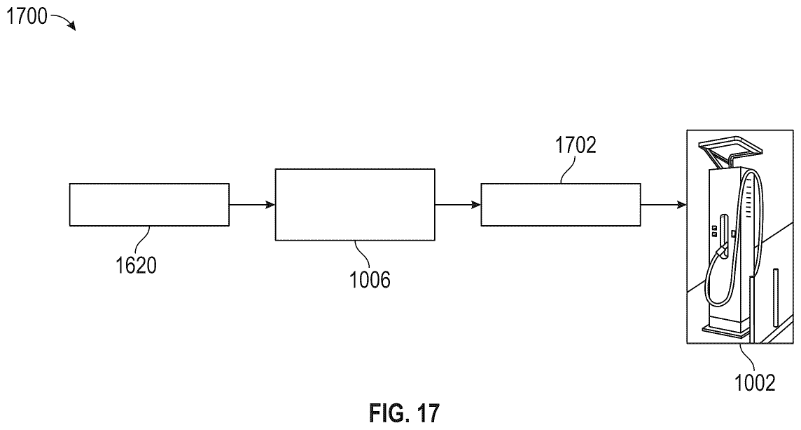

FIG. 17 shows a diagram 1700 of subsequent calculations at the vehicle. The vehicle (e.g., first vehicle 1006) receives the power limit 1620 for the vehicle calculated at the back office. The vehicle then performs calculations to determine a power station requirement 1702 for the vehicle. This power station requirement 1702 is then sent to the charger 1002.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method of operating a charging station, comprising:
receiving a first departure time and first power requirement for a first vehicle when the first vehicle is coupled to a charging station;
charging the first vehicle at a first charging rate to meet the first departure time for the first vehicle;
receiving a second departure time and second power requirement for a second vehicle when the second vehicle is coupled to the charging station after the first vehicle is coupled to the charging station;
charging the second vehicle at a second charging rate to meet the second departure time for the second vehicle;
receiving a third departure time and third power requirement for a third vehicle when the third vehicle is coupled to the charging station after the first vehicle and the second vehicle are coupled to the charging station;
pausing charging of at least one of the first vehicle and the second vehicle, whereas charging of the first vehicle is paused when a first estimated charging time for the first vehicle is earlier than the first departure time and charging of the second vehicle is paused when a second estimated charging time for the second vehicle is earlier than the second departure time; and
charging the third vehicle at the charging station while the at least one of the charging of the first vehicle and the charging of the second vehicle is paused.

2. The method of claim 1, further comprising transferring power to the third vehicle from the one of the first vehicle and the second vehicle for which charging is paused.

3. The method of claim 2, further comprising requesting a permission from an owner of the one of the first vehicle and the second vehicle for which charging is paused to discharge power from the one of the first vehicle and the second vehicle to the third vehicle.

4. The method of claim 1, further comprising establishing a first priority for the first vehicle and a second priority the second vehicle and providing a first charge power for the first vehicle and a second charge power for the second vehicle based on the first priority and the second priority.

5. The method of claim 4, further comprising establishing the first priority and the second priority based on a first utility curve for the first vehicle and a second utility curve for the second vehicle.

6. The method of claim 1, further comprising resuming charging of the one of the first vehicle and the second vehicle when one of a calculated remaining charging time for the first vehicle is equal to or greater than a difference between the first departure time for the first vehicle and a current time and the calculated remaining charging time for the second vehicle is equal to or greater than a difference between the second departure time for the second vehicle and the current time.

7. The method of claim 1, wherein the charging station is one of: (i) a public charging station; and (ii) a residential charging station.

8. A charging station, comprising:
a first charging cord for connecting to a first vehicle;
a second charging cord for connecting to a second vehicle;
a third charging cord for connecting to a third vehicle;
a processor configured to:
receive a first departure time and first power requirement for the first vehicle when the first vehicle is coupled to the charging station;
charge the first vehicle at a first charging rate to meet the first departure time for the first vehicle;
receive a second departure time and second power requirement for the second vehicle when the second vehicle is coupled to the charging station after the first vehicle is coupled to the charging station;
charge the second vehicle at a second charging rate to meet the second departure time for the second vehicle;
receive a third departure time and third power requirement for a third vehicle when the third vehicle is coupled to the charging station after the first vehicle and the second vehicle are coupled to the charging station;
pause charging of at least one of the first vehicle and the second vehicle, whereas charging of the first vehicle is paused when a first estimated charging time for the first vehicle is earlier than the first departure time and charging of the second vehicle is paused when a second estimated charging time for the second vehicle is earlier than the second departure time; and
charge the third vehicle at the charging station while the at least one of the charging of the first vehicle and the charging of the second vehicle is paused.

9. The charging station of claim 8, wherein the processor is further configured to transfer power to the third vehicle from the one of the first vehicle and the second vehicle for which charging is paused.

10. The charging station of claim 9, wherein the processor is further configured to request a permission from an owner of one of the first vehicle and the second vehicle for which charging is paused to discharge power from the one of the first vehicle and the second vehicle to the third vehicle.

11. The charging station of claim 8, wherein the processor is further configured to establish a first priority for the first vehicle and a second priority the second vehicle and provide a first charge power for the first vehicle and a second charge power for the second vehicle based on the first priority and the second priority.

12. The charging station of claim 11, wherein the processor is further configured to establish the first priority and the second priority based on a first utility curve for the first vehicle and a second utility curve for the second vehicle.

13. The charging station of claim 8, wherein the processor is further configured to resume charging of the one of the first vehicle and the second vehicle when one of a calculated remaining charging time for the first vehicle is equal to or greater than a difference between the first departure time for the first vehicle and a current time and the calculated remaining charging time for the second vehicle is equal to or greater than a difference between the second departure time for the second vehicle and the current time.

14. The charging station of claim 8, wherein the charging station is one of:
(i) a public charging station; and (ii) a residential charging station.

15. A charging system, comprising:
a charging station for charging a first vehicle, a second vehicle and a third vehicle;
a back office including a processor configured to:
receive a first departure time and first power requirement for the first vehicle when the first vehicle is coupled to the charging station;
charge the first vehicle at a first charging rate to meet the first departure time for the first vehicle;
receive a second departure time and second power requirement for the second vehicle when the second vehicle is coupled to the charging station after the first vehicle is coupled to the charging station;
charge the second vehicle at a second charging rate to meet the second departure time for the second vehicle;
receive a third departure time and third power requirement for a third vehicle when the third vehicle is coupled to the charging station after the first vehicle and the second vehicle are coupled to the charging station;
pause charging of at least one of the first vehicle and the second vehicle, whereas charging of the first vehicle is paused when a first estimated charging time for the first vehicle is earlier than the first departure time and charging of the second vehicle is paused when a second estimated charging time for the second vehicle is earlier than the second departure time; and
charge the third vehicle at the charging station while the at least one of the charging of the first vehicle and the charging of the second vehicle is paused.

16. The charging system of claim 15, wherein the charging station is configured to request a permission from an owner of one of the first vehicle and the second vehicle which is paused to discharge power from the one of the first vehicle and the second vehicle to the third vehicle.

17. The charging system of claim 16, wherein the processor is further configured to request a permission from an owner of one of the first vehicle and the second vehicle for which charging is paused to allow transfer of power to the third vehicle.

18. The charging system of claim 15, wherein the processor is further configured to establish a first priority for the first vehicle and a second priority the second vehicle and provide a first charge power for the first vehicle and a second charge power for the second vehicle based on the first priority and the second priority.

19. The charging system of claim 18, wherein the processor is further configured to establish the first priority and the second priority based on a first utility curve for the first vehicle and a second utility curve for the second vehicle.

20. The charging system of claim 15, wherein the processor is further configured to resume charging of one of the first vehicle and the second vehicle when one of a calculated remaining charging time for the first vehicle is equal to or greater than a difference between the first departure time for the first vehicle and a current time and the calculated remaining charging time for the second vehicle is equal to or greater than a difference between the second departure time for the second vehicle and the current time.
